(19) United States
(12) Patent Application Publication
(10) Pub. No.: US 2022/0156710 A1
(43) Pub. Date: May 19, 2022

(54) RECURRING AND EVENT TRIGGERED PAYMENT METHODS

(71) Applicant: Jack Shauh, San Diego, CA (US)

(72) Inventor: Jack Shauh, San Diego, CA (US)

(21) Appl. No.: 17/526,113

(22) Filed: Nov. 15, 2021

Related U.S. Application Data
(60) Provisional application No. 63/113,916, filed on Nov. 15, 2020.

(51) Int. Cl. G06Q 20/12; G06Q 20/32; G06Q 20/42

(52) U.S. Cl. CPC G06Q 20/127; G06Q 20/42; G06Q 20/3223

(57) ABSTRACT

An electronic mobile recurring billing and mobile event triggered billing method using a payment processing server programmed to effectuate the operations of receiving from a network device a registration order as the basis for automatically establishing a payment configuration including a subscription ID with associated payment information, and a mobile identity to a mobile payment device. The payment process server determines a payment requirement for the subscription ID, retrieves payment information from a database using the subscription ID and sends a payment request message to the mobile payment device for payment. A Payment request message can be sent in SMS/MMS or email and can include an URL with embedded payment information.

### CROSS-REFERENCE TO RELATED APPLICATION

This application claims the benefit of U.S. Provisional Application No. 63/113,916, filed 15 Nov. 2020.

### FIELD OF THE INVENTION

This invention relates to mobile payment systems.

More particularly, the present invention relates to remote mobile payment for recurring and event triggered payments and the like.

### BACKGROUND OF THE INVENTION

In the payments industry, mobile payments systems are becoming more widely used. Mobile payment applications as a virtual credit/debit card are starting to be provided to mobile devices such as smart phones, tablets, watches and other wearable devices, and the like. Mobile payment methods currently include Apple Pay, Android Pay, Samsung Pay etc. Mobile payment can provide strong security to prevent fraud by implementing EMV (Europay, MasterCard and Visa) Integrated Circuit Card Specifications for Payment Systems. Furthermore, mobile payment can provide strong security by implementing EMV Payment Tokenization Specifications, or a vendor specific payment token scheme.

In today's payment environment, the customer can make a subscription order for products or services of a recurring or an event triggered nature. For example, the customer can place a subscription order for vitamin supplements of a recurring nature, which requires payment at each recurring period. Or the customer can purchase a new refrigerator water filter to replace the old one when the old water filter's filtration capability reaches the 10% threshold, which causes the filter-replacement event to be triggered. To pay for the purchase in today's payment environment, the customer provides payment information such as credit or debit card number, card holder name, expiry date, etc. to the merchant's website through his/her web browser of the customer device and the merchant server stores customer's card information in the database for future charge. For example, the customer device can be a PC or smart phone. When the scheduled recurring payment is due or the event to replace a part is triggered, e.g. ordered by the customer, the merchant can send an authorization request with payment information, and the amount to pay to the payment network. After the card issuing bank approves the transaction, the merchant will then ship the merchandise to the customer. This purchase process can be used to acquire physical merchandise. Alternatively, recurring payment can also be for recurring bill payment such as mortgage payments or utilities bill payments and the like.

While effective, this method is not secure. Card information must be given to the merchants. This card information is then stored by the merchant for future payments. Moreover, the customers may not receive a charge reminder from the merchant prior to each recurring payment or event triggered payment. Therefore, a more secure solution is needed. Additionally, because the customer's card is automatically charged at each recurring period (or at each event triggered event), and the customer does not authorize each individual payment charge, the payment process is prone to future dispute with regards to if customer actually gives consent to each payment charge.

It would be highly advantageous, therefore, to remedy the foregoing and other deficiencies inherent in the prior art.

It is an object of the present invention to provide a secure recurring and event triggered payment method and system.

Another object of the present invention is to provide a secure recurring and event triggered payment method allowing payer to approve each payment.

### SUMMARY OF THE INVENTION

Briefly, to achieve the desired objects and advantages of the instant invention, provided is an electronic mobile recurring payment and mobile event triggered payment method. The method includes registering with a payment processing server, the payment processing server programmed to effectuate the operations of automatically establishing a payment configuration, the payment configuration including a subscription ID, payment information associated with the subscription ID and a mobile identity to a mobile payment device having mobile payment capability and associated with the subscription ID. The payment processing server stores the payment configuration in a database by the payment processing server, then determines when a payment requirement is due for the subscription ID. The payment processing server retrieves payment information from the database using the subscription ID upon determining the payment requirement is due and sends a payment request message to the mobile payment device using the mobile identity associated with the subscription ID. Communication is established between the mobile payment device and the payment processing server and the payment processing server sends a payment authorization request to the mobile payment device where the customer authorizes payment. The mobile payment device creates an encrypted payment data using a payment platform carried thereby upon authorization by the customer. The mobile payment device sends encrypted payment data to the payment processing server and the payment processing server sends encrypted payment data to a payment network for payment processing. The payment processing server receives a payment notice from the payment network, the payment notice indicating either a declined transaction or an approved transaction. The processing server sends an authorization indication to the merchant device indicating either a declined transaction or an approved transaction and the merchant device initiates product shipment upon receiving the authorization indication indicating an approved transaction.

Also provided is an electronic billing system including the steps of a payment processing server serving a networked device over an internet, a non-transitory computer readable storage medium that is not a signal, storing computer executable instructions that when executed by the payment processing server cause the processor to effectuate operations comprising receiving from the networked device a registration order subscribing to one of a recurring payment configuration and an event trigger payment configuration; and automatically establishing a payment configuration based on the registration order, the payment configuration comprising a subscription ID, payment information associated with the subscription ID, and a mobile identity of a mobile payment device having mobile payment capability and associated with the subscription ID; storing the payment configuration in a database; determining a payment requirement for the subscription ID; retrieving payment information from the database using the subscription ID; and sending a payment request message to the mobile payment device using the mobile identity associated with the subscription ID.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is simplified block diagram of a recurring and/or event triggered payment system according to the present invention;

FIG. 2 is a schematic of a recurring payment procedure according to the present invention;

FIGS. 3a and 3b illustrate examples of a web portal to subscribe for recurring purchase/payment according to the present invention;

FIG. 4 is a schematic of an event triggered payment procedure according to the present invention;

FIG. 5 is a flow chart a recurring payment procedure according to the present invention;

FIG. 6 is a flow chart an event trigger payment procedure according to the present invention; and

FIG. 7 is a simplified block diagram of functional modules in the payment processing server according to the present invention.

### DETAILED DESCRIPTION OF THE PREFERRED EMBODIMENTS

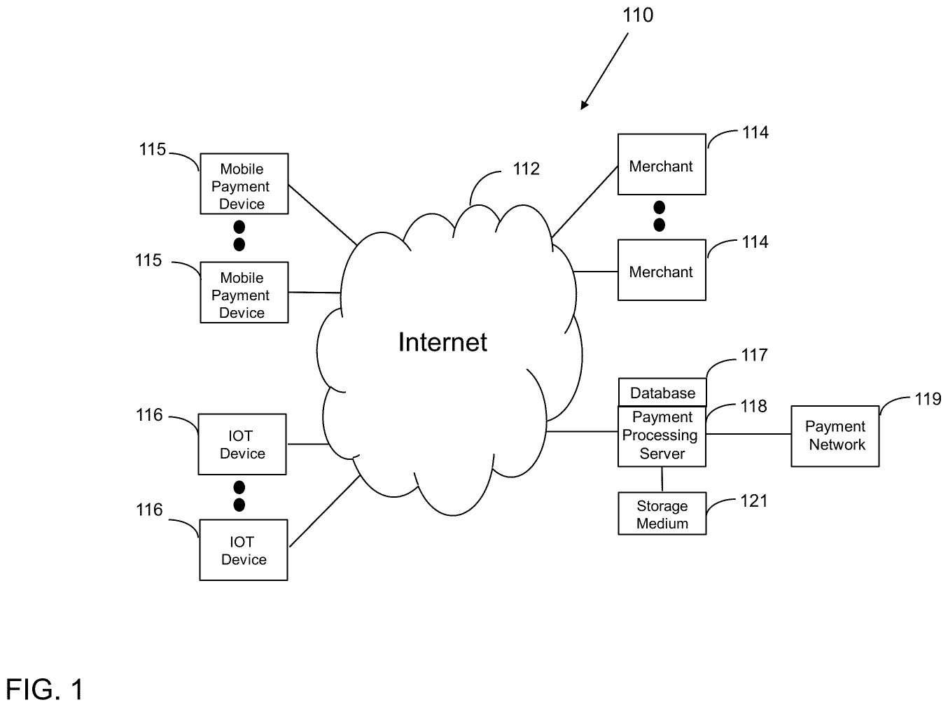

Turning now to the drawings in which like reference characters indicate corresponding elements throughout the several views, attention is first directed to FIG. 1 which illustrates a recurring and/or event triggered payment system 110 according to the present invention. System 110 includes an internet 112, such as the World Wide Web commonly used globally, to facilitate communication between various elements as will be described presently. A merchant device 114 is a server or other device capable of communicating with other devices or a server through internet 112. Merchant device 114 is used by the seller of merchandise or services (merchant) to provide a portal through internet 112, thereby providing access for the customer to subscribe to a recurring purchase configuration and/or an event triggered purchase configuration. A mobile payment device 115, used by the customer, is capable of making mobile payments using platforms such as Apple Pay, Google Pay and the like. Mobile payment device 115 can connect to internet 112 to receive payment requests and send payment tokens (payment token is the surrogate card number or the device PAN (Primary Account Number) as defined in EMVCO tokenization spec, Apple Pay, Google Pay, etc.) to request transaction authorization. For example, mobile payment device 115 can be a smart phone, a wearable device, a tablet, a car dashboard and the like. Internet 112 can be accessed through 2G/3G/4G/5G cellular network, WiFi, LAN, etc., and the like. Commonly, smart phone vendors include mobile wallets (also referred to as platforms) in the smart phones, such as Apple Pay in iPhones, Google Pay in Android phones, which can store a payment token (this is the surrogate card number as defined in EMVCO tokenization spec, Apple Pay, Google Pay, etc.) in a secure element of the platform to prevent the real card number from being stolen. The Internet of things (IoT) are physical objects (or groups of such objects) that are embedded with sensors, processing ability, software, and other technologies, and that connect and exchange data with other devices and systems over the Internet or other communications networks. An IoT Device 116, used in the present system, is a device that can send UUID (a unique identifier to identify an instance of the merchandise) to initiate event triggered purchases through internet 112. Again, internet 112 can be accessed by 2G/3G/4G/5G cellular network, WiFi, LAN, etc., and the like.

A payment processing server 118, having access to a database 117, is coupled through internet 112 for communication to merchant device 114 and mobile payment device 115. Payment processing server 118 is directed by a non-transitory computer readable storage medium 121 that is not a signal, storing computer executable instructions that when executed by the payment processing server cause the payment processing server to effectuate operations for processing recurring or event triggered payments. Payment processing server 118 interfaces with mobile payment device 115 through internet 112 to receive a payment token (a payment token is a surrogate card number or a device PAN (Primary Account Number as defined in EMVCO tokenization spec, Apple Pay, Google Pay, etc.). A payment network 119 is coupled in communication with payment processing server 118 to process transaction therefrom in a conventional and known manner. Payment network 119 includes a payment gateway, acquiring processor, issuing processor, and brand network (e.g. Visa, MasterCard, or American Express), all well known in the art and not described in detail herein. Payment Processing Server 118 can provide service to a plurality of mobile payment devices 115, a plurality IoT devices 116, and one or multiple Merchants devices 114. Payment processing server 118 can be provided by the operator of merchant device 114, or payment processing server 118 can be provided by a third-party service provider to multiple merchant devices 114 as shown in FIG. 1.

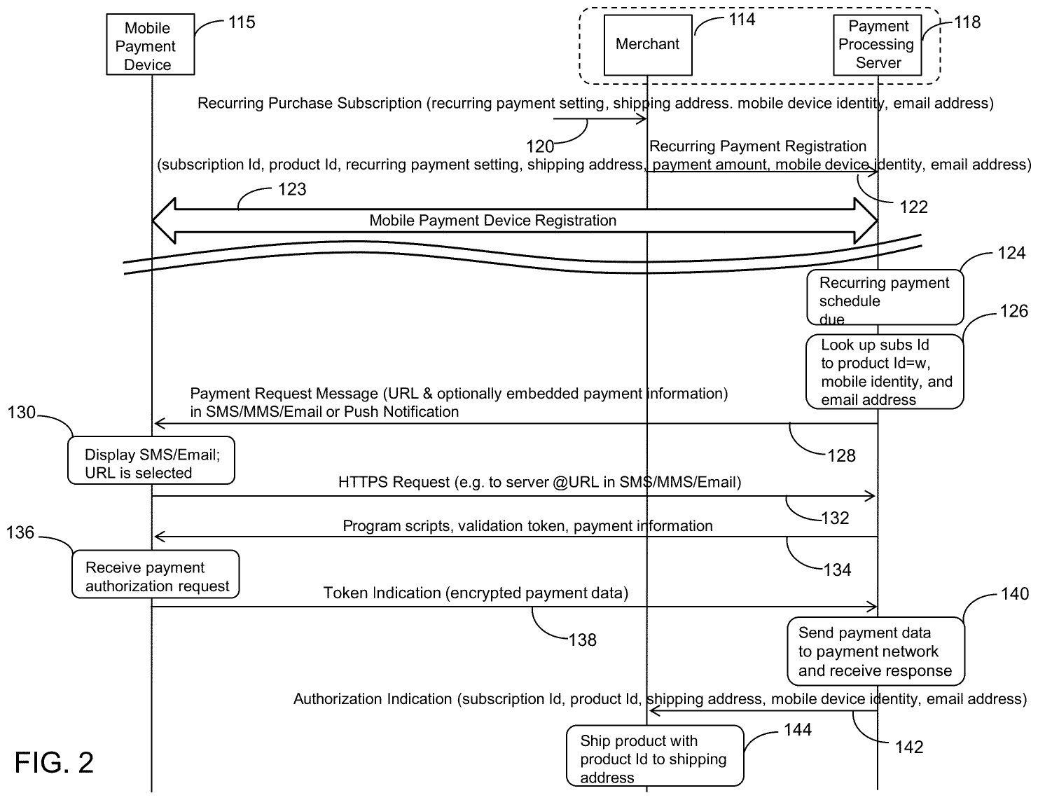

Referring now to FIG. 2, an example of a recurring payment procedure is shown for making payments when using the recurring payment configuration. A dashed box circling merchant device 114 and payment processing server 118 illustrates that payment processing server 118 can be part of merchant device 114. Alternatively, payment processing server 118 can belong to a 3rd party company that provides payment service to the merchant.

The process begins with merchant device 114 receiving a subscription to a payment configuration. In this case, a recurring purchase subscription order is submitted by a customer, designated step 120 to subscribe to the recurring purchase configuration. The recurring purchase subscription order includes information provided by the customer such as a recurring payment schedule, mobile identity (e.g. mobile phone number) for mobile payment device 115, email address, shipping address, etc., and the like. For example, the customer can use mobile payment device 115 to connect to the merchant device 114 in doing so. Merchant device 114 assigns a subscription Id to represent the subscription order the customer just placed. Merchant device 114 sends a registration message, in this case, a recurring payment registration message, to payment processing server 118 as step 122. The recurring payment registration message contains the subscription Id, merchandise product Id, recurring payment setting, shipping address, payment amount, mobile device identity and email address. Non-transitory computer readable storage medium 121, that is not a signal, stores computer executable instructions that when executed by payment processing server 118 cause the payment processing server to effectuate operations as will be disclosed below. The description of the following operation of payment process server 118 should be taken as being directed by executable instructions by non-transitory computer storage medium 121 even though, for simplicity, the specific language is not used in each instance. Payment processing server 118, stores all the information for the corresponding subscription Id in database 117. The subscription Id is assigned by merchant device 114 as the identity of the recurring purchase and payment. In this manner, a subscription for a recurring payment configuration has been established with the payment processing server 118.

An optional step 123 includes the customer registering mobile payment device 115 with payment processing server 118. For example, mobile payment device 115 can download a mobile application to process payments with payment processing server 118, such as receiving push notification of payment requests. Payment processing server 118 can verify mobile payment device 115 with the mobile identity or email address received in step 120.

Payment processing server 118 then determines, using a if and when a specific payment is required. In the recurring payment configuration this includes payment process server 118 determining the recurring payment amount due and calculating the next due date in a step 124 for the registered recurring payment. Payment processing server 118 then retrieves payment information such as the merchandise product Id, mobile identity, email address, etc. from database 117 for the specific recurring payment using the subscription ID, in a step 126. Payment processing server 118 can query merchant device 114 to get the price of merchandise, product Id and associated shipping cost to determine the payment amount; it is possible that the payment amount may vary in each payment, which is not shown in the figure. Alternatively, payment processing server 118 can get the payment amount from database 117 as payment information.

Payment processing server 118 sends a payment request message in SMS/MMS (Short Message Service/Multimedia Messaging Service), email or push notification to mobile payment device 115 in a step 128. For example, the message sent in push notification can include payment amount, currency code, description of payment, merchant name and identity, merchant's supported brand network (e.g. any of Visa, MasterCard, and/or American Express), etc. Alternatively the message sent in SMS/MMS or email can include a URL address to payment processing server 118, with embedded payment information including payment amount, currency code, merchant name or identity, merchant's supported brand network (e.g. Visa, MasterCard, and/or American Express), etc., or the message sent in SMS/MMS or email only includes a URL address to payment processing server 118 and the URL address includes a transaction Id for this specific transaction or subscription Id, which can be used to retrieve the payment information. Using a push notification does not need a URL because a push notification is received by the mobile application which already knows the payment processing server's URL address.

Mobile payment device 115 receives the payment request message, and in the case of SMS/MMS or email, the URL is displayed to the customer by the mobile payment device 115. Using mobile payment device 115, the customer can then select the displayed URL link in SMS/MMS or email in a step 130.

In the case of SMS/MMS or email, mobile payment device 115 sets up an HTTPS session with payment processing server 118 pointed to by the URL address provided in the received SMS/MMS or email in a step 132 in response to the customer selecting the URL link. In the case of a push notification message received by the mobile application on mobile payment device 115, a HTTPS session can be a long-lasting session and does not need to set up for each transaction.

Once an HTTP session is established, in the case of SMS/MMS or email, payment processing server 118 downloads a program script and a validation token to mobile payment device 115 in a step 134 referred to as a payment authorization request. The program script can include specific payment information, including payment amount, currency code, merchant name or identity, merchant's supported brand network (e.g. Visa, MasterCard, and/or American Express), etc. which is retrieved from database 117 using the transaction Id or the subscription Id. The program script can also include a brief product description, product quantity, merchant name, etc. If the SMS/MMS or email includes a URL address with embedded payment information, the payment information is stored in the URL which can be retrieved by the program script. The program script can run at mobile payment device 115 to interact with the API of the mobile wallet (platform) to retrieve encrypted payment data by providing some or all of payment information as input, e.g. payment amount, currency code, merchant identity, merchant's supported brand network (e.g. Visa, MasterCard, and/or American Express), etc. The validation token is used to identify a valid merchant website or a valid payment processing server and be able to interact with the mobile wallet in mobile payment device 115. In the case of a push notification message received by the mobile application, the push notification does not require a validation token because the mobile application can authenticate itself to the mobile wallet in the mobile payment device and program script is already in the mobile application.

Upon receiving the payment authorization request from payment processing server 118, mobile payment device 115 can display some payment information, e.g. payment amount, brief product description, product quantity, merchant name. A step 136 includes mobile payment device 115 displaying information and prompting the customer to authorize using biometric input, PIN code or the like. During step 136, mobile payment device 115 will invoke the mobile wallet API to process the payment information and retrieve encrypted payment data for this payment transaction. The procedure is executed by program script downloaded in step 134 or by the mobile application pre-installed in optional step 123.

Upon authorization of the payment by the customer, mobile payment device 115 sends encrypted payment data (payment data can include payment token, payment amount, currency code, cryptogram, etc.) to the payment processing server 118 in a step 138.

Upon receiving the encrypted payment data, payment processing server 118 sends the encrypted payment data to payment network 119 to approve the transaction and receives a payment notice, either declining the transaction or approving the transaction in a step 140.

Upon receiving the payment notice from payment network 119 in step 140, payment processing server 118 sends an authorization indication to merchant device 114 with authorization status, merchandise product Id, shipping address, mobile identity, and email address in a step 142. When merchant device 114 receives the authorization indication from payment process server 118, merchant device 114 can initiate product shipment to the customer at the shipping address if the payment notice included approval of the transaction or cancel shipment if the transaction was declined in a step 144.

Alternatively, in step 136, the customer can reject this payment, which can signal to payment processing server 118 and/or merchant device 114 to cancel this particular transaction, terminate this subscription or update the subscription (not shown in the figure).

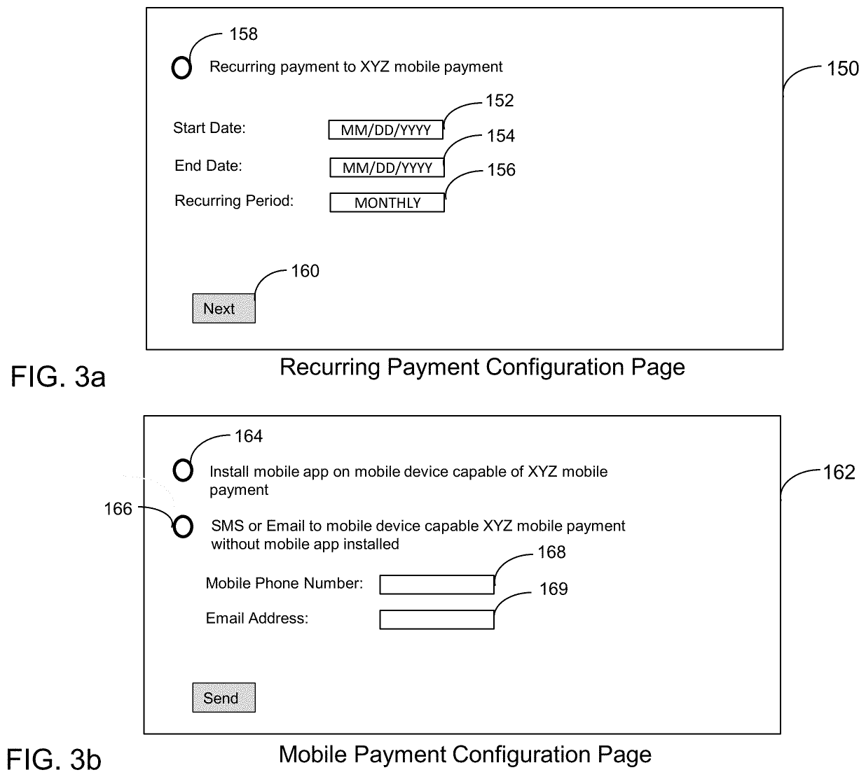

Turning now to FIGS. 3a and 3b, an example of web portal pages for establishing a subscription order with merchant device 114 is shown. The subscription order enables payment processing server 118 to store recurring period, mobile identity and email address (along with subscription Id, merchandise product Id, shipping address, etc.) and process recurring purchases/payments. On a first page 150 illustrated in FIG. 3a, the web portal can allow the customer to enter start date 152, end date 154 and recurring period 156 after clicking button of recurring payment 158 with XYZ mobile payment. For example, XYZ can be Apple Pay, Google Pay, etc. At the end, the customer clicks “Next” button 160. On a second page 162, as shown in FIG. 3b, in order for the customer to receive a payment request from payment processing server 118, 2 options are provided to the customer. The first option 164 is to download a mobile application to customer's mobile phone, e.g. iPhone, Android Phone. The second option 166, is to receive SMS or email without requiring a mobile application installed for this service. To download and install a mobile application, the mobile payment device is required to register with the payment processing server as described in Step 123 described in FIG. 2.

If the customer selects option 164 of installing mobile application, the web portal can redirect the web page to the app store of the corresponding mobile OS (Operating System) vendor, e.g. iOS or Android, to download the mobile application. If the customer selects option 166 of receiving SMS or email without a mobile application, the customer must fill in mobile phone number 168 and email address 169 to a receive payment request.

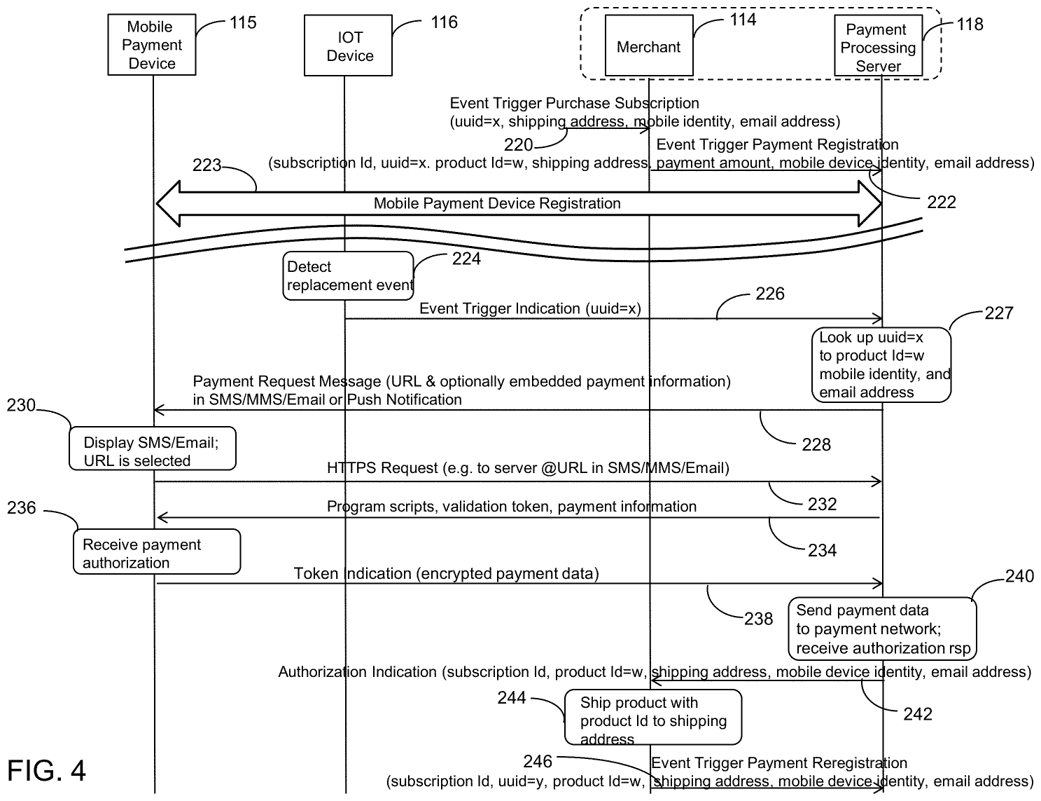

Referring now to FIG. 4, the process steps in an example of an event triggered payment procedure is shown for making payments when using the event triggered payment configuration. A dashed box circling merchant device 114 and payment processing server 118 illustrates that payment processing server 118 can be operated by the operator of merchant device 114. Alternatively, payment processing server 118 can belong to a 3rd party company that provides payment service separate from the operator of merchant device 114.

The process begins with merchant device 114 receiving a subscription to a payment configuration. In this case, an event trigger purchase subscription order is submitted by a customer, designated step 220. The event trigger purchase subscription order includes information provided by the customer such as a UUID, shipping address, mobile identity (e.g. mobile phone number), email address, etc. For example, the customer can use mobile payment device 115 to connect to merchant device 114 through a web portal as previously described. The customer can also use a smartphone camera to capture the UUID encoded in a bar code or a QR (Quick Response) code format from a product's (such as a refrigerator's water filter) label. Merchant device 114 assigns a subscription Id to represent the event triggered subscription order that the customer just placed.

Merchant device 114 sends a registration message, in this case, an event trigger payment registration message, to payment processing server 118 as step 222. The event trigger payment registration message includes subscription Id, Universal Unique Identifier (UUID), merchandise product Id, shipping address, payment amount, mobile device identity and email address. The UUID can indicate a unique instance of the merchandise. For example, UUID=x can relate to the merchandise product Id=w and serial number. Payment processing server 118 can store all the information for the corresponding subscription Id in database 117. The subscription Id is assigned by merchant device 114 as the identity of the event trigger purchase and payment. In this manner, a subscription for an event trigger payment configuration has been established with the payment processing server 118.

An optional step 223 includes the customer registering mobile payment device 115 with payment processing server 118. For example, mobile payment device 115 can download a mobile application to process payments with payment processing server 118, such as receiving push notification of payment requests. Payment processing server 118 can verify mobile payment device 115 with the mobile identity or email address received in step 220.

Payment processing server 118 then determines if and when a specific payment is required. In the event trigger payment configuration this includes IoT device 116 detecting a need to replace a part of or the entire device in a step 224. For example, IOT device 116 can be a refrigerator and a part to be replaced can be the water filter of the drinking water dispenser at the refrigerator front panel. For example, some sensor can detect the deterioration of water quality with water filter; or some processor can count total time when the dispenser of drinking water has been turned on exceeding a threshold; or some processor can record the time that has elapsed since the filter was installed exceeding a threshold. IoT device 116 then sends an event trigger indication message to payment processing server 118 as step 226. The event trigger indication message includes the UUID of the part or the entire device to be replaced. In order for IoT device 116 to send the event trigger indication message to payment processing server 118, IoT device 116 needs to be configured to access internet 112, e.g. WiFi SSID and password is provided using a provisional interface to IoT device 116. IoT device 116 needs to be configured with the URL address of payment processing server 118. Furthermore, IoT device 116 needs to be registered with payment processing server 118 to set up secured communication session, e.g. installing a security key between IoT device 116 and payment processing server 118.

Payment processing server 118 receives the UUID contained in the event trigger indication message and retrieves the merchandise product Id=w, mobile identity, email address, etc. from database 117 as step 227. If the payment amount varies in each payment event, payment processing server 118 can query merchant device 114 to get the price of the merchandise product Id (=w) and its associated shipping cost to determine the payment amount; otherwise, payment processing server 118 can get payment the amount from database 117.

Payment processing server 118 sends a payment request message in SMS/MMS (Short Message Service/Multimedia Messaging Service), email or push notification to mobile payment device 115 in a step 228. For example, the message sent in push notification can include payment amount, currency code, description of payment, merchant name and identity, merchant's supported brand network (e.g. any of Visa, MasterCard, and/or American Express), etc. Alternatively the message sent in SMS/MMS or email can include a URL address to payment processing server 118, with embedded payment information including payment amount, currency code, merchant name or identity, merchant's supported brand network (e.g. Visa, MasterCard, and/or American Express), etc., or the message sent in SMS/MMS or email only includes a URL address to payment processing server 118 and the URL address includes a transaction Id for this specific transaction or subscription Id, which can be used to retrieve the payment information. Using a push notification does not need a URL because a push notification is received by the mobile application which already knows the payment processing server's URL address.

Mobile payment device 115 receives the payment request message, and in the case of SMS/MMS or email, the URL is displayed to the customer by the mobile payment device 115. Using mobile payment device 115, the customer can then select the displayed URL link in SMS/MMS or email in a step 230.

In the case of SMS/MMS or email, mobile payment device 115 sets up an HTTPS session with payment processing server 118 pointed to by the URL address provided in the received SMS/MMS or email in a step 232 in response to the customer selecting the URL link. In the case of a push notification message received by the mobile application on mobile payment device 115, a HTTPS session can be a long-lasting session and does not need to set up for each transaction.

Once an HTTP session is achieved, in the case of SMS/MMS or email, payment processing server 118 downloads a program script and a validation token to mobile payment device 115 in a step 234 referred to as a payment authorization request. The program script can include specific payment information, including payment amount, currency code, merchant name or identity, merchant's supported brand network (e.g. Visa, MasterCard, and/or American Express), etc. which is retrieved from database 117 using the transaction Id or the subscription Id. The program script can also include a brief product description, product quantity, merchant name, etc. If the SMS/MMS or email includes a URL address with embedded payment information, the payment information is stored in the URL which can be retrieved by the program script. The program script can run at mobile payment device 115 to interact with the API of the mobile wallet (platform) to retrieve encrypted payment data by providing some or all of payment information as input, e.g. payment amount, currency code, merchant identity, merchant's supported brand network (e.g. Visa, MasterCard, and/or American Express), etc. The validation token is used to identify a valid merchant website or a valid payment processing server and be able to interact with the mobile wallet in mobile payment device 115. In the case of a push notification message received by the mobile application, the push notification does not require a validation token because the mobile application can authenticate itself to the mobile wallet in the mobile payment device and program script is already in the mobile application.

Upon receiving the authorization request from payment processing server 118, mobile payment device 115 can display some payment information, e.g. payment amount, brief product description, product quantity, merchant name. A step 236 includes mobile payment device 115 displaying information and prompting the customer to authorize using biometric input, PIN code or the like. During step 236, mobile payment device 115 will invoke the mobile wallet API to process the payment information and retrieve encrypted payment data for this payment transaction. The procedure is executed by program script downloaded in step 234 or by the mobile application pre-installed in optional step 223.

Upon authorization of the payment by the customer, mobile payment device 115 sends encrypted payment data (payment data can include payment token, payment amount, currency code, cryptogram, etc.) to the payment processing server 118 in a step 238.

Upon receiving the encrypted payment data, payment processing server 118 sends the encrypted payment data to payment network 119 to approve the transaction and receives a payment notice, either declining the transaction or approving the transaction in a step 240.

Upon receiving the payment notice from payment network 119 in step 240, payment processing server 118 sends an authorization indication to merchant device 114 with authorization status, merchandise product Id, shipping address, mobile identity, and email address in a step 242. When merchant device 114 receives the authorization indication from payment process server 118, merchant device 114 can initiate product shipment to the customer at the shipping address if the payment notice included approval of the transaction or cancel shipment if the transaction was declined in a step 244.

Alternatively, in step 236, the customer can reject this payment, which can signal to payment processing server 118 and/or merchant device 114 to cancel this particular transaction, terminate this event or update the event (not shown in the figure).

After merchant device 114 initiates shipment of the merchandise, merchant device 114 sends an event trigger payment reregistration message to payment processing server 118 as step 246. The event trigger payment reregistration message contains subscription Id, new Universal Unique Identifier (UUID=y), merchandise product Id=w, shipping address, mobile device identity and email address. The information of shipping address, mobile device identity and email address can be known from the subscription Id. Merchant device 114 can acquire the new UUID by scanning a bar code which is used to identify the unique instance of this merchandise. After payment processing server 118 receives the event trigger payment reregistration message, it adds the new UUID and its corresponding payment amount to the database entry of the associated subscription Id.

Similarly to FIG. 2, the Merchant's web portal associated with merchant device 114 can allow a customer to subscribe for event trigger purchase/payment to enable merchant device 114 and payment processing server 118 to store mobile identity, email address, subscription Id, merchandise product Id, UUID, etc. and process event trigger purchase/payment. For example, Recurring Period being “On the need for replacement basis” can be chosen in FIG. 3a. In order to receive a payment request, in the web portal page, the customer can select the option of installing mobile application to the mobile payment device, e.g. iPhone, Android Phone; or select the option of receiving SMS or email without a mobile application. To download and install a mobile application, the mobile payment device is required to register with the Payment Processing Server as described in Step 223 of FIG. 4.

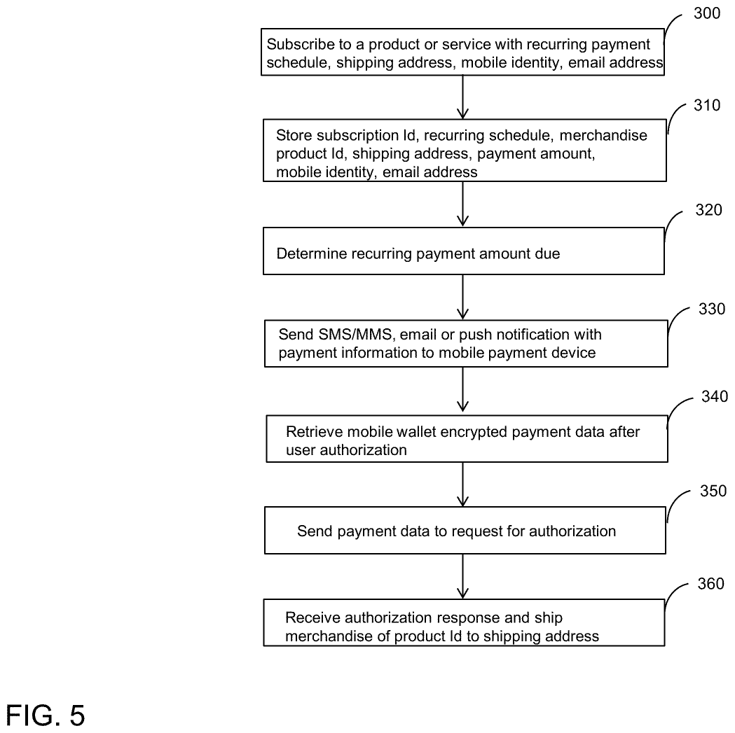

Referring now to FIG. 5, an example of a recurring payment process corresponding to procedures described in conjunction with FIG. 2, is illustrated as a flow chart.

Block 300: The customer subscribes to a subscription order by providing recurring payment schedule (i.e. subscription duration and recurring period), mobile identity, shipping address and email address.

Block 310: The system stores the subscription Id with associated recurring payment schedule, merchandise product Id, shipping address, payment amount, mobile identity, and email address.

Block 320: The system determines recurring payment amount due.

Block 330: The system sends SMS/MMS, email or push notification with payment information to the mobile payment device.

Block 340: The mobile payment device retrieves mobile wallet encrypted payment data after user authorization.

Block 350: The system sends payment data to request for authorization.

Block 360: The system receives authorization response and ship the merchandise of the correct product Id to the shipping address.

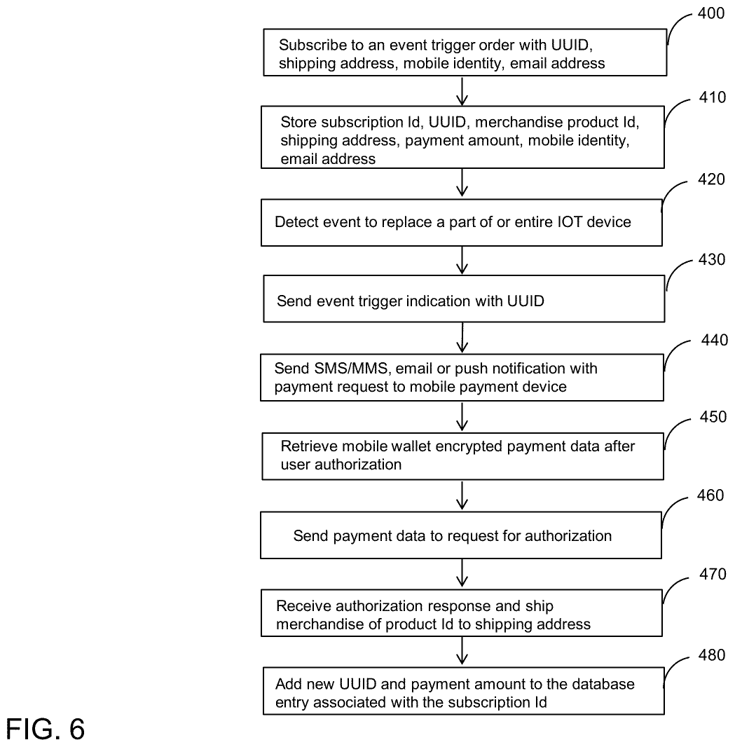

FIG. 6 shows the example of the flow chart of an event triggered payment process corresponding to procedures in FIG. 4.

Block 400: The customer subscribes to an event triggered subscription order by providing UUID, mobile identity, shipping address and email address.

Block 410: The system stores the subscription Id with associated UUID, merchandise product Id, shipping address, payment amount, mobile identity, and email address.

Block 420: The system detects the event to replace a part of or the entire IOT device.

Block 430: The IOT device sends event trigger indication message with UUID.

Block 440: The system sends SMS/MMS, email or push notification with payment information to the mobile payment device.

Block 450: The mobile payment device retrieves mobile wallet encrypted payment data after user authorization.

Block 460: The system sends payment data to request for authorization.

Block 470: The system receives authorization response and ships the merchandise of the product Id to the shipping address.

Block 480: The system adds the new UUID and its corresponding payment amount to the database entry associated with the subscription Id.

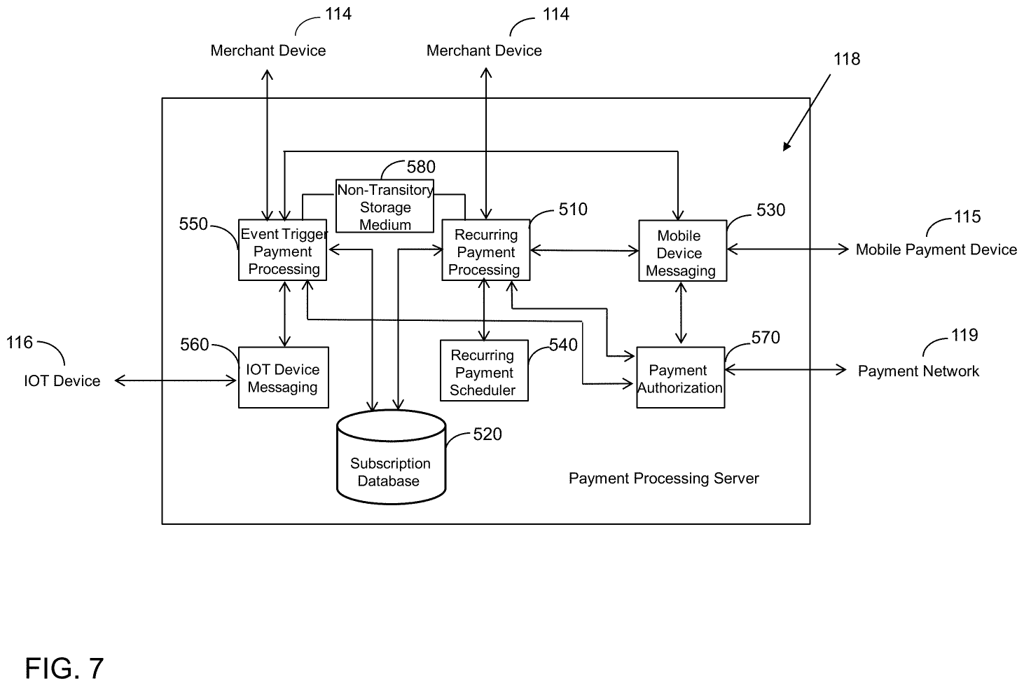

Turning now to FIG. 7, an example of detailed modules of payment processing server 118 is illustrated. Payment processing server 118 includes a recurring payment processing module 510. Recurring payment processing module 510 is coupled in communication with merchant device 114 through internet 112 to receive the recurring payment registration from merchant device 114 described in step 122. If payment processing server 118 is provided by the operator of merchant device 114, module 510 can also provide a web portal for customer to place a subscription order with a recurring payment configuration and mobile payment configuration as described in association with FIG. 3. Recurring payment processing module 510 provisions the recurring payment configuration using a subscription database module 520 (previously described as database 117) coupled thereto. Recurring payment processing module 510 sends a mobile identity or an email address to a mobile device messaging module 530 by retrieving associated information from database module 520 in order to send a payment request upon receiving a signal from a recurring payment scheduler module 540 that a recurring payment scheduled for a subscription Id is due or will be due. Recurring payment processing module 510 notifies merchant device 114 of the authorization status in order to ship merchandise.

Payment processing server 118 preferably further includes an event trigger payment processing module 550. Event trigger payment processing module 550 is coupled in communication with merchant device 114 through internet 112 to receive the event trigger payment registration from merchant devices 114. If payment processing server 118 is operated by the operator of merchant device 114, module 550 can also provide a web portal for a customer to register for the event trigger payment with a mobile setting. Event trigger payment processing module 550 provisions the event trigger payment configuration using subscription database module 520 (previously described as database 117) coupled thereto. Event trigger payment processing module 550 receives an event trigger indication from an IoT device messaging module 560. Event trigger payment processing module 550 forwards a mobile identity or email address to mobile device messaging module 530 by database lookup (database 520) upon receiving event trigger indication from IoT device messaging module 560. Event trigger payment processing module 550 notifies merchant device 114 of the authorization status to ship merchandise.

Recurring payment scheduler module 540 receives the recurring payment setting from recurring payment processing module 510 for a specific subscription Id and determines the recurring payment due date or predicts the recurring payment due date associated with each subscription Id of recurring payments. Recurring payment scheduler module 540 sends signals to recurring payment processing module 510 with regards to the recurring payment due date associated with a subscription id.

Mobile device messaging module 530 receives the mobile identity and email address from recurring payment processing module 510 or event trigger payment processing module 550 and sends a payment request message to mobile payment device 115 using SMS/MMS, or email or push notification. Depending on the selected process, mobile device messaging module 530 downloads program scripts to mobile payment device 115 and sends a validation token to mobile payment device 115. Mobile device messaging module 530 requests the mobile wallet service provider for a session validation token such that mobile payment device 115 is able to retrieve the encrypted payment data. It can also create a URL with embedded payment information and send the URL in SMS/MMS or email. The payment token from mobile payment device 115 is received by mobile device messaging module 530 which forwards it to a payment authorization module 570. Mobile device messaging module 530 handles the registration from the mobile application installed on the mobile payment device 115.

Payment authorization module 570 sends the authorization request to payment network 119 and receives authorization status back. Payment authorization module 570 interacts with recurring payment processing module 510 or event trigger payment processing module 550 to process the payment transaction authorization.

IoT device messaging module 560 receives the event trigger indication message from IoT device 116 and forwards the payment request message to event trigger payment processing module 550. IoT device messaging module 560 supports IoT device 116 to register to set up a secured communication session.

Subscription database module 520 provides storage for the payment configuration, e.g. subscription Id, transaction Id, UUID, merchandise product Id, shipping address, payment amount, mobile device identity and email address. It provides the stored configuration upon request by recurring payment processing module 510 or event trigger payment processing module 550 by using subscription Id, transaction Id or UUID.

It will be understood by those of ordinary skill in the art that recurring payment processing module 510 and event trigger payment processing module 550 include processors whose function is directed by a non-transitory computer readable storage medium 580 that is not a signal, storing computer executable instructions that when executed by recurring payment processing module 510 and event trigger payment processing module 550 cause recurring payment processing module 510 and event trigger payment processing module 550 to effectuate operations for processing recurring or event triggered payments as described throughout the specification. It will also be understood that a single processor directed by a non-transitory computer readable storage medium can perform the functions described. The module description is solely intended to provide clarity of the various functions.

The above recurring and event triggered payment methods present advantages over the old payment method. First, mobile payment is used, in which the credit/debit card number is not stored at the merchant, neither is the real card number sent to the merchant at each times of payment. Security is greatly improved. Second, at each of the times of recurring and event triggered payment, the customer can receive payment notification, and the customer needs to clearly authorize using biometric input or PIN code, and therefore customer has awareness and full control on the payment.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. An electronic mobile recurring payment and mobile event triggered payment method, comprising the steps of:
registering with a payment processing server, the payment processing server programmed to effectuate the operations of automatically establishing a payment configuration, the payment configuration including a subscription ID, payment information associated with the subscription ID and a mobile identity to a mobile payment device having mobile payment capability and associated with the subscription ID;
the payment processing server storing the payment configuration in a database by the payment processing server;
the payment processing server determining a payment requirement is due for the subscription ID;
the payment processing server retrieving payment information from the database using the subscription ID upon determining the payment requirement is due;
the payment processing server sending a payment request message to the mobile payment device using the mobile identity associated with the subscription ID;
establishing communication between the mobile payment device and the payment processing server;
the payment processing server sending a payment authorization request to the mobile payment device;
authorizing payment on the mobile payment device by a customer;
the mobile payment device creating encrypted payment data using a payment platform carried thereby upon authorizing payment by the customer;
the mobile payment device sending encrypted payment data to the payment processing server;
the payment processing server sending encrypted payment data to a payment network for payment processing;
the payment processing server receiving a payment notice from the payment network, the payment notice indicating either a declined transaction or an approved transaction;
the processing server sending an authorization indication to the merchant device indicating either a declined transaction or an approved transaction; and
the merchant device initiating product shipment upon receiving the authorization indication indicating an approved transaction.

2. A mobile payment method as claimed in claim 1 wherein the step of registering with a payment processing server comprises the steps of:
accessing a web portal from the merchant device and subscribing to one of a recurring payment configuration and an event trigger payment configuration;
entering the mobile identity to the mobile payment device; and
the merchant device sending a registration of the subscribed one of the recurring payment configuration and the event trigger payment configuration to the payment processing server.

3. A mobile payment method as claimed in claim 2 wherein the step of registering with a payment processing server further comprises the steps of:
registering the mobile payment device directly with the payment processing server to subscribe to one of a recurring payment configuration and an event trigger payment configuration; and
the payment processing server downloading a mobile application to the mobile payment device to enable processing payments.

4. A mobile payment method as claimed in claim 1 wherein the step of determining a payment requirement comprises the steps of:
the payment processing server programmed to effectuate the operation of automatically calculating, the next due date associated with the subscription ID; and
determining a recurring payment amount due for the next due date associated with the subscription ID;

5. A mobile payment method as claimed in claim 1 wherein the step of determining a payment requirement comprises the steps of:
an IoT device detecting a need for a replacement; and
the IoT device sending an event trigger indication message to the payment processing server, the event trigger indication message including the UUID of the replacement.

6. A mobile payment method as claimed in claim 1 wherein the step of sending a payment authorization request to the mobile payment device further includes the step of downloading a program script and a validation token to the mobile payment device.

7. An electronic mobile recurring billing and mobile event triggered billing method, comprising the steps of:
a payment processing server programmed to effectuate the operations of:
a) receiving from a network device a registration order; based on the registration order, automatically
b) establishing a payment configuration, the payment configuration comprising a subscription ID, payment information associated with the subscription ID and a mobile identity to a mobile payment device having mobile payment capability and associated with the subscription ID;
c) storing the payment configuration in a database;
d) determining a payment requirement for the subscription ID;
e) retrieving payment information from the database using the subscription ID;
f) sending a payment request message in SMS/MMS or email to the mobile payment device using the mobile identity associated with the subscription ID, wherein the payment request message can include an URL with embedded payment information.

8. The electronic mobile recurring billing and mobile event triggered billing method as claimed in claim 7, further comprising the steps of:
the payment processing server programmed to effectuate the operation of:
a) automatically sending a payment authorization request to the mobile payment device upon establishment of communication with the mobile payment device;
b) receiving encrypted payment data generated by the mobile payment device using a payment platform carried thereby upon authorizing payment by the customer;
c) sending the encrypted payment data to a payment network for payment processing;
d) receiving a payment notice from the payment network, the payment notice indicating either a declined transaction or an approved transaction; and
e) sending an authorization indication to the network device indicating either a declined transaction or an approved transaction.

9. The electronic mobile recurring billing and mobile event triggered billing method as claimed in claim 7, wherein the step of receiving from a network device a registration order, further comprising the step of subscribing to one of a recurring payment configuration and an event trigger payment configuration.

10. The electronic mobile recurring billing and mobile event triggered billing method as claimed in claim 7, wherein the step of determining a payment requirement for the subscription ID, further comprising the step:
the payment processing server programmed to effectuate the operation of automatically calculating, the next due date associated with the subscription ID; and
determining a recurring payment amount due for the next due date associated with the subscription ID.

11. The electronic mobile recurring billing and mobile event triggered billing method as claimed in claim 7, wherein the step of determining a payment requirement for the subscription ID, further comprising the step the payment processing server receiving an event trigger indication message from an IoT device which has detected a need for a replacement, the event trigger indication message including the UUID of the replacement.

12. An electronic billing system, comprising the steps of:
a payment processing server serving a networked device over an internet;
a non-transitory computer readable storage medium that is not a signal, storing computer executable instructions that when executed by the payment processing server cause the processor to effectuate operations comprising:
a) receiving from the networked device a registration order subscribing to one of a recurring payment configuration and an event trigger payment configuration; and automatically
b) establishing a payment configuration based on the registration order, the payment configuration comprising a subscription ID, payment information associated with the subscription ID, and a mobile identity of a mobile payment device having mobile payment capability and associated with the subscription ID;
c) storing the payment configuration in a database;
d) determining a payment requirement for the subscription ID;
e) retrieving payment information from the database using the subscription ID; and
f) sending a payment request message in SMS/MMS or email to the mobile payment device using the mobile identity associated with the subscription ID, wherein the payment request message can include an URL with embedded payment information.

13. The electronic billing system, comprising the steps of:
the payment processing server programmed to effectuate the operation of:
a) automatically sending a payment authorization request to the mobile payment device upon establishment of communication with the mobile payment device;
b) receiving encrypted payment data generated by a payment platform carried by the mobile payment device upon authorizing payment by the customer;
c) sending the encrypted payment data to a payment network for payment processing;
d) receiving a payment notice from the payment network, the payment notice indicating either a declined transaction or an approved transaction; and
e) sending an authorization indication to the network device indicating either a declined transaction or an approved transaction.

14. The electronic billing system as claim in claim 12, wherein the step of determining a payment requirement for the subscription ID, further comprising the step:
the payment processing server programmed to effectuate the operation of automatically calculating, the next due date associated with the subscription ID; and
the payment processing server programmed to effectuate the operation of automatically determining a recurring payment amount due for the next due date associated with the subscription ID.
